(19) United States
(12) Patent Application Publication
(10) Pub. No.: US 2010/0133899 A1
(43) Pub. Date: Jun. 3, 2010

(54) TWO-CONDUCTOR FIELD DEVICE FOR PROCESS AUTOMATION TECHNOLOGY FOR CONNECTING AT LEAST ONE SENSOR ELEMENT

(75) Inventors: Thomas Joegel, Immenstadt (DE); Stephan Konrad, Rieden (DE); Alfred Umkehrer, Hopferau (DE)

Correspondence Address: BACON & THOMAS, PLLC, 625 SLATERS LANE, FOURTH FLOOR, ALEXANDRIA, VA, 22314-1176, US

(73) Assignee: Endress + Hauser Wetzer GmbH, Nesselwang (DE)

(21) Appl. No.: 12/448,347

(22) PCT Filed: Nov. 30, 2007
(86) PCT No.: PCT/EP2007/063066

§ 371 Date: Jan. 13, 2010

(30) Foreign Application Priority Data
Dec. 19, 2006 (DE) 10 2006 060 447.4

(51) Int. Cl. H04B 3/54

(52) U.S. Cl. 307/1

(57) ABSTRACT

A two-conductor field device for process automation technology for connecting at least one sensor element includes a first supply part, which via a first 2-conductor connection is connectable with a fieldbus. The field device is supplied completely with energy via the fieldbus. The two-conductor field device includes a second supply part, which is connected to the first supply part and which serves via a second 2-conductor-connection for energy supply of a sensor bus. Further provided are a fieldbus communication unit, which is connected with the first 2-conductor-connection and with the first supply part and which serves for data-exchange via the fieldbus, and a sensor bus communication unit, which is connected with the second 2-conductor-connection and the second supply part and which serves for data exchange via the sensor bus. Connected with the fieldbus communication unit, the sensor bus communication unit and the first supply part is a processing module. The fieldbus and the sensor bus are galvanically isolated from one another.

The invention relates to a two-conductor field device for process automation technology for connecting at least one sensor element, as such device is defined in the preamble of claim 1.

Known from U.S. Pat. No. 6,574,515 is a two-conductor field device as defined in the Field of the Invention, to which a plurality of sensor elements are connectable and which is supplied with energy via a two-conductor, process control loop. The measured values delivered from the sensor elements are conditioned in a processing module and transmitted to a superordinated unit via a communication interface, which is connected to the two-conductor, process control loop.

In the case of this two-conductor field device, pluralities of sensor elements are combined into sensor groups, and each group is connected via a multiplexer with the processing module. Data transmission between multiplexer and processing module occurs digitally. For galvanic isolation of the sensor elements from the processing module, an isolator is provided after the multiplexer in the communication line. Energy supply of the individual sensor elements occurs via a separate voltage supply line, in which, for galvanic isolation, a further isolator is required.

A disadvantage of this apparatus is that each sensor group requires galvanic isolation both in the communication line and in the voltage supply line.

A further disadvantage of this apparatus is that four lines must be brought to each sensor element, this being an aspect that requires a considerable cabling effort.

An object of the invention is, therefore, to provide a two-conductor field device for process automation technology for connecting at least one sensor element, which does not have the above named disadvantages, which, especially, requires only a small cabling effort, which is simple to isolate galvanically and simple and cost-effective to manufacture.

This object is achieved by the features set forth in claim 1.

Advantageous further developments of the invention are set forth in the dependent claims.

An essential idea of the invention is, in the case of a two-conductor field device, which is supplied via a fieldbus with energy, to connect the individual sensor elements to the processing unit via a sensor bus and to provide a galvanic isolation between the fieldbus and the sensor bus. The galvanic isolation can be arranged, corresponding to the three examples of embodiments set forth below, in different ways in the field device.

In this way, the number of required galvanic isolations is reduced. Moreover, also the cabling effort to the individual sensor elements becomes smaller.

The figures of the drawing show as follows:

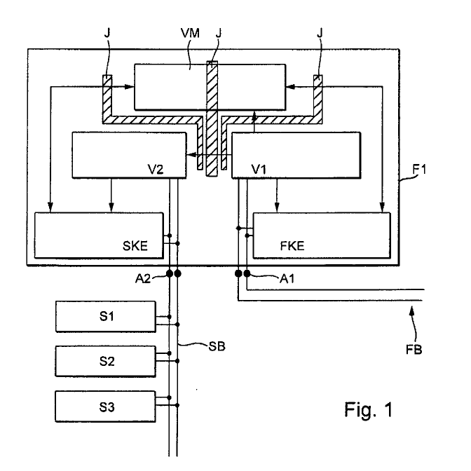

FIG. 1 block diagram of a two-conductor field device of the invention;

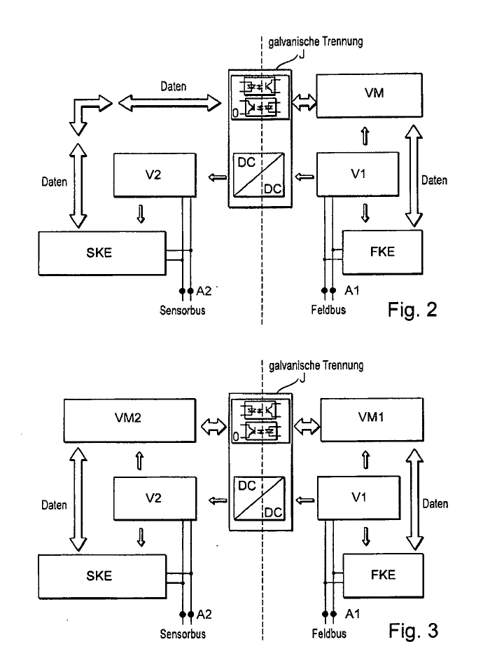

FIG. 2 first alternative embodiment of a field device according to FIG. 1;

FIG. 3 second alternative embodiment of a field device according to FIG. 1;

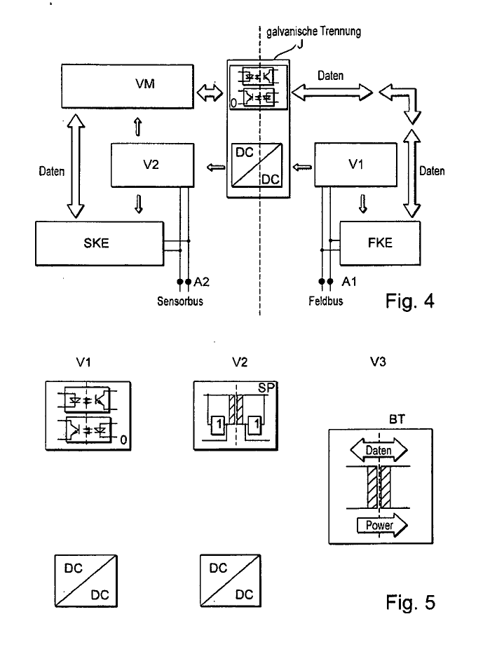

FIG. 4 third alternative embodiment of a field device according to FIG. 1; and

FIG. 5 three variants of a galvanic isolation circuit for a field device according to FIG. 1.

FIG. 1 shows, schematically, a two-conductor field device for process automation technology for connecting at least one sensor element. The field device F1 includes a fieldbus communication unit FCU, which is connected with a fieldbus FB via a first two-conductor connection A1. Likewise connected with the first two-conductor connection A1 is a supply unit V1. The supply unit V1 serves for energy supply of the individual electrical components of the field device F1. The entire energy for the field device F1 is, as usual in the case of two-conductor field devices, delivered via the fieldbus FB. Besides the first supply unit V1, a second supply unit V2 is provided, which is connected via a second two-conductor connection A2 with a sensor bus SB. Connected to the sensor bus SB is a plurality of sensor elements S1, S2, S3. The second supply unit V2 serves for energy supply of the sensor elements connected to the sensor bus SB. It draws its energy likewise from the supply unit V1.

Further connected with the second two-conductor connection A2 is a sensor communication unit SCU, which also is supplied with energy from the second supply unit V2. Serving as central processing unit for the data (e.g. measured values) delivered from the sensor elements S1, S2, S3 is a processing module PM, which is connected with the sensor bus communication unit SCU and with the fieldbus communication unit FCU. In the processing module PM, the measured values of the sensor elements are conditioned and forwarded to the fieldbus communication unit FCU for transmission via the fieldbus. Communication via the fieldbus FB can occur, for example, according to the Profibus standard. The sensor bus system can be, for example, a HART multidrop system or a Profibus system.

The fieldbus communication unit FCU and the sensor bus communication unit SCU are, in each case, responsible for the data transmission via their associated bus systems (physical, bus interface, or telegram construction, as the case may be).

The three hatched beams I illustrate three alternatives, where galvanic isolation makes sense.

An essential advantage of the invention is that the galvanic isolation must only be provided at two locations. Moreover, the cabling effort for the individual sensor elements is significantly smaller.

Three alternative embodiments of the invention are schematically presented in FIGS. 2-4 with, in each case, a galvanic isolation circuit I.

FIG. 2 shows the galvanic isolation circuit I arranged between the first and second supply units V1 and V2, as well as between the processing module PM and the sensor bus communication unit SCU. The processing module PM is composed essentially of a microcontroller with CPU and different memory units RAM, ROM, EEPROM.

FIG. 3 shows the galvanic isolation circuit I arranged between the two parts PM1, PM2 of the two-part processing module PM. Each of the two parts PM1, PM2 has its own microcontroller, wherein the microcontroller in the processing module PM1 serves as master and the microcontroller in the processing module PM2 as slave.

FIG. 4 shows the galvanic isolation circuit I arranged between the first and second supply units V1 and V2 as well as between the processing module PM and the fieldbus communication unit FCU.

The galvanic isolation circuit I is, in the case of all three alternatives (FIGS. 2-4) composed of an optocoupler O for the data transmission and a direct voltage converter DC/DC (DC/DC converter) for energy transmission.

FIG. 5 shows that the optocoupler O of variant Var1 can also be replaced by a coil pair CP in a variant Var2. A further variant Var3 is to implement the direct voltage converter DC/DC and the coil pair CP in a single component CT.

In an alternative embodiment of the invention, a separate galvanic isolation can be provided in each of the sensor elements.

The present invention permits, in simple manner, isolation of a plurality sensor elements S1, S2, S3 galvanically from a fieldbus FB.

Translation of German words and/or symbols in the drawing

FIG. 1:

Change “FKE” to --FCU--;

change “SKE” to --SCU--;

change “VM” to --PM--; and

change “J” to --I--.

FIG. 2:

Change “galvanische Trennung” to --Galvanic Isolation--;

change “J” to --I--;

change “VM” to --PM--;

change “Daten” (three occurrences) to --Data--;

change “FKE” to --FCU--;

change “Feldbus” to --Fieldbus--;

change “Sensorbus” to --Sensor Bus--; and

change “SKE” to --SCU--.

FIG. 3

Change “galvanische Trennung” to --Galvanic Isolation--;

change “J” to --I--;

change “VM” (two occurrences) to --PM--;

change “Daten” (two occurrences) to --Data--;

change “FKE” to --FCU--;

change “Feldbus” to --Fieldbus--;

change “Sensorbus” to --Sensor Bus--; and

change “SKE” to --SCU--.

FIG. 4:

Change “galvanische Trennung” to --Galvanic Isolation--;

change “J” to --I--;

change “VM” to --PM--;

change “Daten” (three occurrences) to --Data--;

change “FKE” to --FCU--;

change “Feldbus” to --Fieldbus--;

change “Sensorbus” to --Sensor Bus--; and

change “SKE” to --SCU--.

FIG. 5:

Change “V1” to --Var1--;

change “V2” to --Var2--;

change “V3” to --Var3--;

change “SP” to --CP--;

change “BT” to --CT--; and

change “Daten” to --Data--.

1-4. (canceled)

5. A two-conductor field device for process automation technology for connecting at least one sensor element, comprising:
a first supply part, which is connectable via a first 2-conductor connection with a fieldbus, via which the field device is supplied completely with energy;
a second supply part, which is connected to said first supply part and which serves via a second 2-conductor connection for energy supply of a sensor bus;
a fieldbus communication unit, which is connected with said first 2-conductor connection and said first supply part and which serves for data exchange via said fieldbus;
a sensor bus communication unit, which is connected with said second 2-conductor connection and said second supply part and which serves for data exchange via said sensor bus; and
a processing module, which is connected with said fieldbus communication unit, said sensor bus communication unit and said first supply part, wherein:
said fieldbus and said sensor bus are galvanically isolated from one another.

6. The two-conductor field device as claimed in claim 5, wherein:
the galvanic isolation is provided, respectively, between said processing module and said sensor communication unit, and between said supply part and said supply part.

7. The two-conductor field device as claimed in claim 5, wherein:
the galvanic isolation is provided, respectively, between said processing module and said fieldbus communication unit, and between said supply part and said supply part.

8. The two-conductor field device as claimed in claim 5, wherein:
said processing module is embodied in two parts, and the galvanic isolation is provided, respectively, between said two parts of said processing module, and between said supply part and said supply part.
